(19) United States
(12) Patent Application Publication
(10) Pub. No.: US 2003/0063966 A1
(43) Pub. Date: Apr. 3, 2003

(54) Dual concentric robotic high performance automated tape cartridge system

(76) Inventors: James L. Apple, Boulder, CO (US); Jerry L. Donze, Arvada, CO (US); James C. Faulk, Niwot, CO (US); Robert Billington, Lyons, CO (US); Gerald M. Grammens, Boulder, CO (US); Gerard FitzPatrick, Broomfield, CO (US); Timothy C. Ostwald, Louisville, CO (US)

Correspondence Address: Wayne P. Bailey, Storage Technology Corporation, 1 Storage Tek Drive, Louisville, CO, 80028-4309, US

(21) Appl. No.: 10/237,581

(22) Filed: Sep. 9, 2002

Related U.S. Application Data
(62) Division of application No. 09/451,574, filed on Nov. 30, 1999.

(51) Int. Cl. B65G 1/00

(52) U.S. Cl. 414/273

(57) ABSTRACT

A data storage and retrieval system. In a preferred embodiment, the data storage and retrieval system includes a polygonal array of cells that are inwardly disposed with openings configured to receive data storage units. A first robot unit to transport a data storage unit to and from the polygonal array of cells is located within the polygonal array of cells. A second robot unit is also located within the polygonal array of cells to transport a data storage unit to and from the polygonal array of cells. The second robot unit manipulates the data storage units placed in the cylindrical array of cells independently of the first robot unit.

### BACKGROUND OF THE INVENTION

1. Technical Field

The present invention relates generally to electronic media storage and retrieval and in particular to an improved method and apparatus for restoring and retrieving large amounts of data contained within tape cartridges.

2. Description of Related Art

Storage library systems are capable of storing and rapidly retrieving large quantities of information stored in storage media cartridges. Such storage library systems often use robotic mechanisms to improve the speed of information retrieval and reliability of maintaining the storage library cartridge inventory.

An automatic cartridge library is a system used for handling large amounts of information in a data processing system. These types of systems store and manage large numbers of standardized cassettes containing magnetic tape on which data is recorded. Typically, an automated cartridge library is comprised of arrays of uniquely identified cells in which each cell contains a single tape cartridge. These cells are arranged in arrays or racks for holding many of these cartridges. Each cartridge has identifying information, such as a bar code. A robotic arm, having an optical system for selecting the correct cartridge, is operable within the automated cartridge library to locate a particular cell, retrieve a tape cartridge from the cell, convey the tape cartridge to a tape drive, and insert the tape cartridge into a tape drive.

In many applications, the amount of data is large enough that multiple library storage modules are employed in which each module contains cell arrays and a robotic arm, but does not require additional host computers and does not contain a tape drive. These multiple library storage units are typically arranged adjacent to one another and pass-through ports are provided for passing tape cartridges from one library storage module to an adjacent library storage module. In these systems, a problem exists in automated library systems to facilitate loading and unloading of cartridges when the number of cartridges and drive devices are greater than some threshold of reasonable performance. As a result, a bottleneck is created because the robotic arm within a library module is unable to keep up the requests from a host. For example, exchange rates of over 1,000 tape cartridges per hour strains presently available cartridge tape library systems.

Therefore, it would be advantageous to have an approved method and apparatus for an automated tape cartridge library system having higher performance and better reliability.

### SUMMARY OF THE INVENTION

The present invention provides a data storage and retrieval system. In a preferred embodiment, the data storage and retrieval system includes a polygonal array of cells that are inwardly disposed with openings configured to receive data storage units. A first robot unit to transport a data storage unit to and from the polygonal array of cells is located within the polygonal array of cells. A second robot unit is also located within the polygonal array of cells to transport a data storage unit to and from the polygonal array of cells. The second robot unit manipulates the data storage units placed in the cylindrical array of cells independently of the first robot unit.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows an automated cartridge system (ACS) 100 according to one embodiment of the present invention;

FIG. 2 shows the interface between the host computers and the LSMs;

FIG. 3 shows an LSM in greater detail;

FIG. 4 shows a cross-sectional view of an automated memory cartridge system 400 according to the present invention;

FIGS. 5A-5B show perspective views of a robot suitable for use as robot 110 or robot 150 in FIG. 4;

FIG. 6 shows a block diagram of the robot control system in accordance with the present invention;

FIGS. 7-12 shows alternate configurations of the dual concentric robots 410 and 450 in accordance with the present invention;

FIG. 13 illustrates a concentric robots having redundant arms in accordance with the present invention;

FIG. 14 illustrates an alternate embodiment in which there are four concentric independently rotatable arms within a library storage module 1410 in accordance with the present invention;

FIG. 15 shows a schematic diagram of four independently rotatable arms with off-centered axes of rotation in accordance with the present invention.

### DETAILED DESCRIPTION OF THE PREFERRED EMBODIMENT

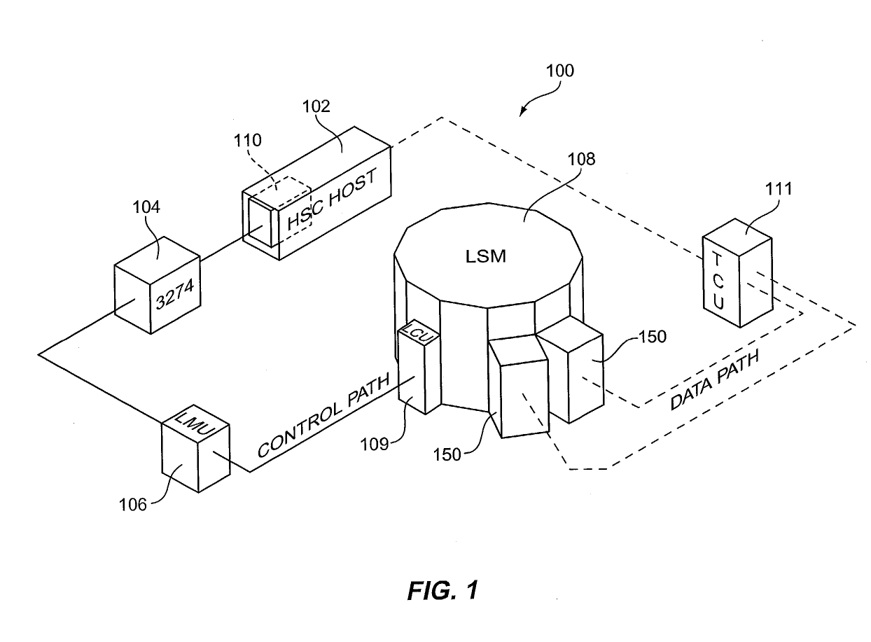

With reference now to the figures, wherein like characters designate like or corresponding parts throughout the several views, there is shown in FIG. 1 an automated cartridge system (ACS) 100 in which a preferred embodiment of the present invention may be implemented. The ACS 100 is designed to operate with an IBM, or IBM-compatible host computer 102 capable of communication with a conventional 327X-type terminal controller 104 as will be described in further detail herein below. Comprised generally of a library management unit (LMU) 106 and a library storage module (LSM) 108, the ACS 100, through its associated host software component (HSC) 110, enables storage and retrieval of magnetic tape cartridges for use by the host computer 102 across a conventional channel 112.

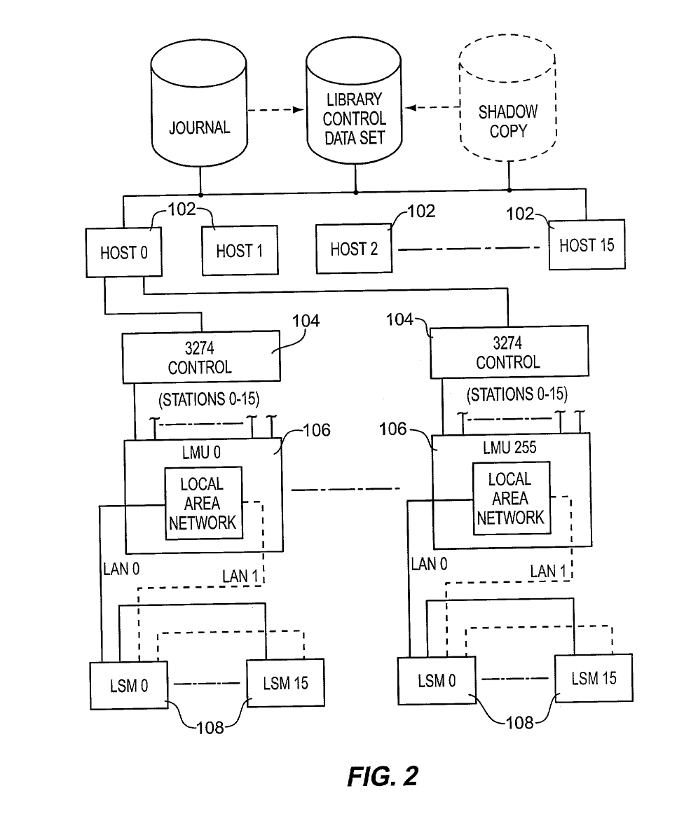

Each LMU 106 serves as the library controller and provides the interface between from one to sixteen host computers 102 and up to 16 LSMs 108, as shown in FIG. 2.

Turning now to FIG. 2, a block diagram of a distributed data processing system is depicted in accordance with a preferred embodiment of the present invention. LMU 106 thus acts as an outboard controller and interprets commands from host computers 102, relaying appropriate instructions to LSM 108 via a control path (shown in solid lines) and a library control unit (LCU) 109. On the other and, the read/write data path (dashed lines) comes directly from the host computer 102, through a tape control unit 111 to the tape transports 150 as will be described further herein below, thereby separating control signals from data signals.

Each LSM 108 provides the necessary mechanisms for automated cartridge handling. It not only provides the storage area for magnetic tape cartridges utilized in the system, but also includes an optical system for identifying the correct cartridge, a servo-controlled, electromechanical means of selecting the proper cartridge and delivering it o the correct tape drive, and a suitable housing to ensure operator safe4ty and data security.

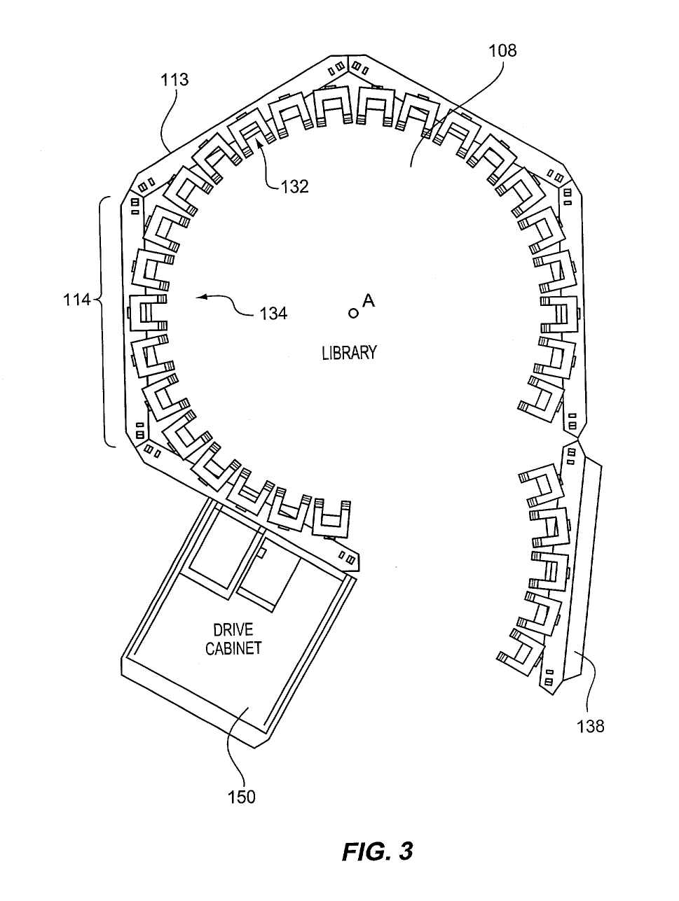

As shown in greater detail in FIG. 3, a diagram of a LSM is shown in which the present invention may be implemented. LSM 108 is comprised generally of an outer housing 113 which includes a plurality of wall segments 114 attached to floor plates (not shown) and disposed about a vertical axis A. A cylindrical array 134 of storage cells 132 is concentrically arranged about axis A, mounted upon the wall segments 114 of the outer housing 113. A clearance door 138 allows for access into the interior of LSM 108. The robotics that manipulate the cartridges within LSM 108 are not depicted in FIG. 3.

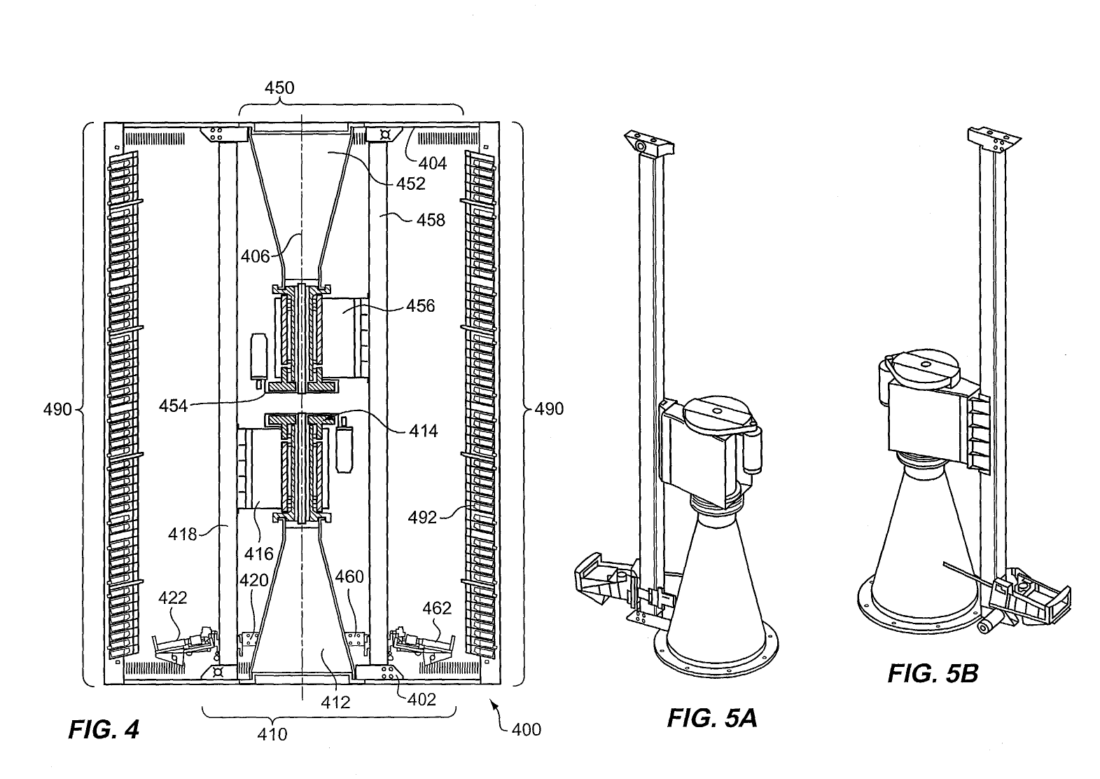

Turning now to FIG. 4, a cross-sectional view of a library storage module is depicted in accordance with a preferred embodiment of the present invention. Library storage module (LSM) 400 may be implemented as LSM 108 in FIG. 1. Automated memory cartridge system 400 includes two robots 410 and 450. Robot 410 is mounted to floor 402 of automated memory cartridge system 400 by way of a number of bolts (not shown) through support 412. Robot 450 is mounted to the ceiling 404 of automated cartridge system 400 by way of a number of bolts (not shown) through support 452. Both robot 410 and robot 450 share the same theta axis 406 of rotation (i.e., dual concentric robots). Each robot, robot 410 and robot 450 operates within a cylindrical or polygonal library 490 containing a plurality of cartridge arrays 492 arranged cylindrically or in a polygonal shape. A major axis is an axis within a polygonal array such as cartridge arrays 492. The major axis is usually, but not always, centrally located within the polygonal array. Furthermore, robot 410 and robot 450 are capable of rotating about center axis 406 approximately two full turns before encountering a mechanical stop. This rotation is a “theta” movement. Collision avoidance is provided by software control, such as robotic control system 600 described below, which control and monitors activities of robot 410 and robot 450 and will limit travel of robot 410 and robot 450 to a location just short of the mechanical stops.

Robot 410, in addition to support 412, also includes a theta drive 414, an arm 416, a Z-channel 418, a Z-transport 420, a Z-motor (not shown), and a hand 422. Similarly, robot 450, in addition to its support 452, also includes a theta drive 454, an arm 456, a Z-channel 458, a Z-transport 460, a Z-motor (not shown), and a hand 462. The purpose of the Z transport mechanism is to provide a means of moving the hand 422 and 462 in a vertical direction. Theta Drive 414 is attached to support 412 and includes a motor that turns an arm 416 about axis 406. Similarly, theta drive 454 is attached to support 452 and includes a motor that turns an arm 458 about axis 406.

Hands 422 and 462 provide the actual handling of the cartridges (not shown). Each hand, hand 422 and hand 462, is attached to a transport that can be moved up and down on its respective Z-channel 418 and 458 (Z move). Each hand, hand 422 and hand 462, is capable of reaching out, gripping a cartridge, and pulling the cartridge out of its storage cell. Hands 422 and 462 can then be moved to another location through a combination of theta and Z moves and placed in another cell, a tape drive, or some other device located within the LSM 400.

Robot 410 and robot 450 are essentially identical with minor differences in the way certain parts are assembled to provide proper orientation for the upper and lower hand assemblies. Robots and LSMs such as those described herein may be obtained from Storage Tek with such modifications as to achieve the apparatus of the present invention. Perspective views of a robot suitable for use as robot 410 or robot 450 are shown in FIGS. 5A and 5B. FIG. 5A shows the robot from an orientation 180 degrees removed from the orientation shown in FIG. 5B.

More details about the construction and operation of the robots 410, 450 and hands 422, 462 as well as other features of automatic storage and retrieval systems may be found in U.S. Pat. No. 4,932,826 issued to Moy, et al. which is incorporated herein by reference.

Each robot, robot 410 and robot 450, has an absolute position detection device that receives power from the opposite robot's supply. This potentially low-resolution device need not be the primary feedback element for rotational position control. The detected absolute position is made available to both robot 410 and robot 450. The primary purpose of the absolute position devices is collision avoidance during full speed operation of both robots 410 and 450. The sensors enable both robots 410 and 450 to operate simultaneously at full speed thus almost doubling performance of the library 490. However, if one robot 410 or robot 450 is rendered disabled, the first mode of collision avoidance is for that robot to be commanded to move clear of the functioning robot's path. In the event that the disabled robot cannot evade potential collision with the remaining functional robot, use is made of the absolute position detection by the active robot. Any action that is not obstructed by the disabled robot is completed at full performance speeds. An action that is obstructed by the disabled robot is carried out at full speed until the vicinity of the disabled robot is reached. The disabled robot is then pushed to a safe area by the active robot at reduced speeds. The absolute position devices are used secondarily during initialization for determining orientation of the two robots.

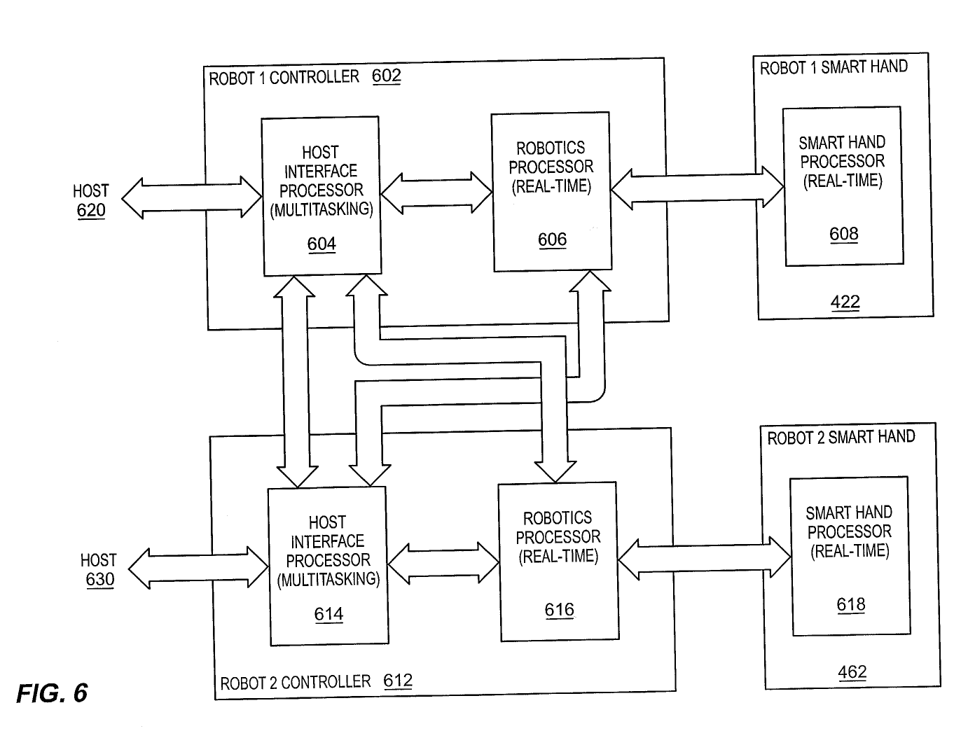

Turning now to FIG. 6, there is shown a block diagram of the robot control system 600 in accordance with the present invention. The presence of the two robots 410 and 450 not only provides for high performance but also establishes redundant hardware for improve reliability. Along with the redundant robotics are redundant electronics and power. The main electronics (robot controllers) 602, 612 and processors 604, 606, 614, and 616 have crossover capability so that in the event of failure of one, the other can operate both robots 410, 450. The system 600 also contains two power supplies with dual line cords so power to the library can come from two different building circuits. Cards are hot pluggable to provide maximum up time in the event of failure. In addition to redundant hardware, code updates may be loaded without interrupting operation of the library.

Two digital signal processing (DSP) processors are used to control each robot, one is on the controller and one is on the hand. Processors 606 and 608 control robot hand 422 while processors 616 and 618 control robot hand 462. Processors 608 and 618 are hand processors used in conjunction with the vision system used to decode cartridge labels, and hand position as determined from targets on the storage arrays. Also, processors 608 and 618 are used to control the reach and grip functions of the hand. A second DSP processor resides within the library control unit (LCU) electronics for each robot. Processors 606 and 616 control the theta and Z robot axes as well as providing direct communications to the hand DSP processors 608 and 618. Both sets of DSP processors are optimized to run in a real-time environment.

A host interface processor (HIP) 604, 614 provides the interface between the external control environment for host 620 and host 630 and the LCU DSP processors 606 and 616. The HIP operation environment is multitasking and the two HIPs 606 and 616 provide fail-over capability.

Returning now to FIG. 4, in addition to twin robots 410 and 450, library 400 contains mechanisms to facilitate insertion and removal of cartridges by the operator. This operation is accomplished through the use of a cartridge access port (CAP) which provides the convenience of loading and unloading through the use of cartridge magazines. The library storage module also has the ability to pass and receive cartridges between other libraries through the use of a cartridge exchange mechanism.

Thus, the present invention utilizing dual concentric robots is able to provide exchange rates of over 1,000 per hour. Each of the two robots has access to the same media and the access is essentially non-reliant on the second robot's activities. Furthermore, access to all drives in the system is equally shared by both robots to the greatest extent possible.

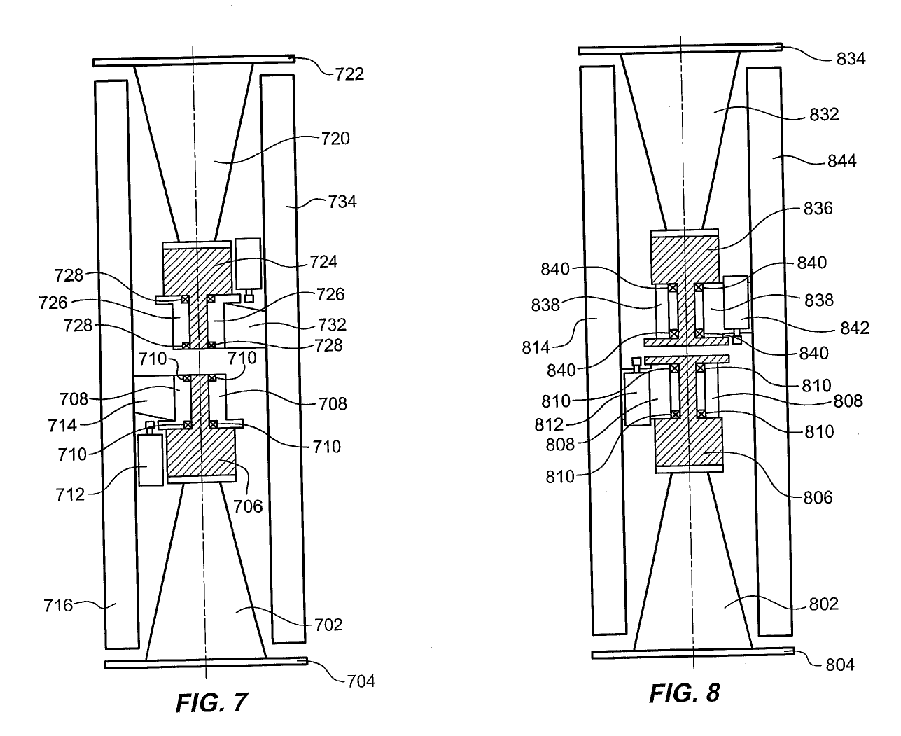

Turning now to FIGS. 7-12, alternate configurations of dual concentric robot 410 and robot 450 are illustrated in accordance with the present invention. For clarity, the library storage module, robotic hands, and other details are not shown in these views.

In FIG. 7 a cross sectional view of dual concentric robots with one robot mounted to the ceiling and one to the floor with fixed motors is illustrated in accordance a preferred embodiment of the present invention. A support 702 is mounted to floor 704 of the library storage module and a column 706 is attached to support 702. A sleeve 708 fits and turns around bearings 710 in column 706. A motor 712 is attached to column 706 and turns a belt (not shown) which in turn, rotates sleeve 708. Sleeve 708 is attached to arm 714 which is in turn attached to Z-channel 716. The rotation of sleeve 708 causes the Z-channel 716 to rotate. A second support 720 is attached to the ceiling 722 of library storage module and a second column 724 is attached to second support 720. A second sleeve 726 fits around second column 724 and rotates on bearings 728 in second column 724. A second motor 730 is attached to column 724 and turns a belt (not shown) which in turn rotates sleeve 726. Sleeve 726 is connected to arm 732, which is, in turn, connected to Z-channel 734. The rotation of sleeve 726 causes Z-channel 734 to rotate.

In FIG. 8 a cross sectional view of dual concentric robots with one robot mounted to the ceiling and one to the floor with motors mounted to the z-column is illustrated in accordance with a preferred embodiment of the present invention. A support 802 is attached to floor 804 of library storage module and a column 806 is attached to support 802. A sleeve 808 fits around column 806 and rotates on bearings 810 in column 806. A motor 812 is attached to sleeve 808 and is also attached to Z-channel 814. Motor 812 turns a belt (not shown) which loops around column 806 causing motor 812 and, in turn, Z-channel 814 to rotate about column 806. A second support 832 is attached to ceiling 834 of library storage module and a second column 836 is attached to second support 832. A second sleeve 838 fits around column 806 and rotates on bearings 840 in second column 836. A second motor 842 is attached to second sleeve 838 and is also attached to Z-channel 844. Second motor 842 turns a belt (not shown) which loops around second column 836 causing second motor 842 and, in turn, Z-channel 844 to rotate about second column 836.

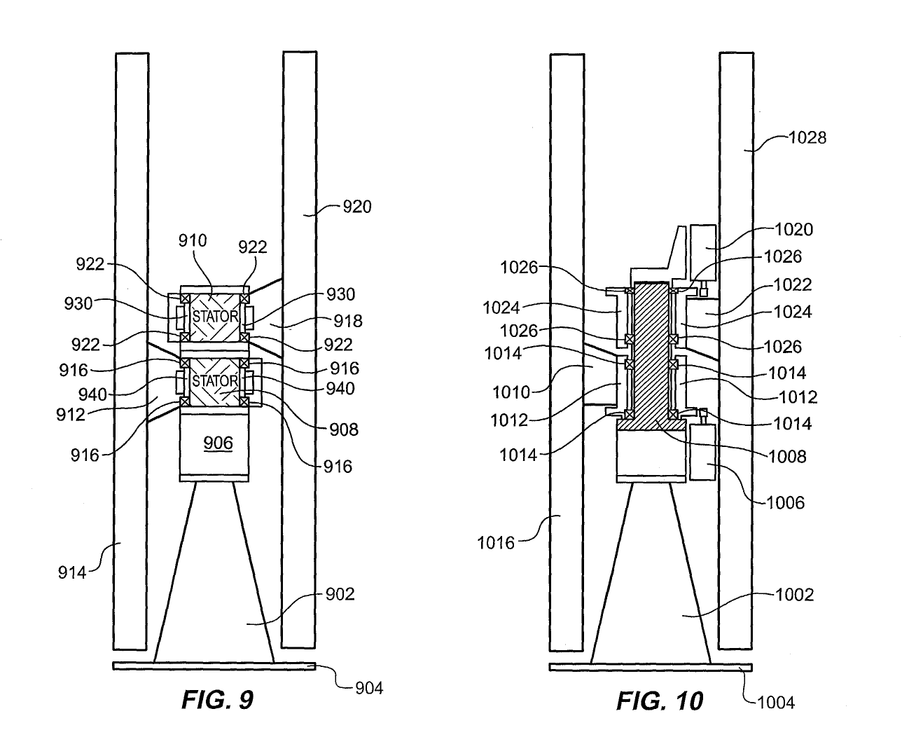

In FIGS. 9 a cross sectional diagram of dual concentric robots both mounted to the floor with inline motors is illustrated in accordance with a preferred embodiment of the present invention. A support 902 is mounted to floor 904 of the library storage module. The motors driving the theta movements of each arm are placed in-line within column 906 that is attached to support 902. One motor is mounted above the other motor. The lower motor is comprised of stator 908, bearings 916, and a rotor 940. The upper motor is comprised of stator 910, bearings 922, and rotor 930. The stators 908 and 910 are fixed in position, i.e., attached to support 902 via column 906. Rotor 930 is attached to arm 918 which is in turn connected to Z-channel 914 and rotates about stator 910. Rotor 940 is attached to arm 912 which is in turn connected to Z-channel 920 and rotates about stator 916. Thus, the rotors 930 and 940 allow for theta movement of arms 918 and 912. Bearings 916 allow rotor 940 to turn around stator 908 and bearings 922 allow rotor 930 to turn around stator 910. The Z-channels 914 and 920 may be attached to robotic hands (not shown).

In FIG. 10 a cross sectional diagram of dual concentric robots both mounted to the floor having external motors is illustrated in accordance with a preferred embodiment of the present invention. A support 1002 is attached to the floor 1004 of the library storage module. An external motor 1006 is attached to a column 1008 to drive the theta movement of arm 1010. Arm 1010 is attached to a sleeve 1012 which fits around column 1008 and turns over lubricated bearings 1014 in column 1008. Also attached to arm 1010 is Z-channel 1016 to which the robotic hand (not shown) attaches. A second external motor 1020 is attached to column 1008 above the first motor 1006 to drive the theta movement of arm 1022. Arm 1022 is attached to a second sleeve 1024, which fits around column 1008 and turns over lubricated bearings 1026 in column 1008. Also attached to arm 1022 is Z-channel 1028 to which a robotic hand (not shown) may be attached.

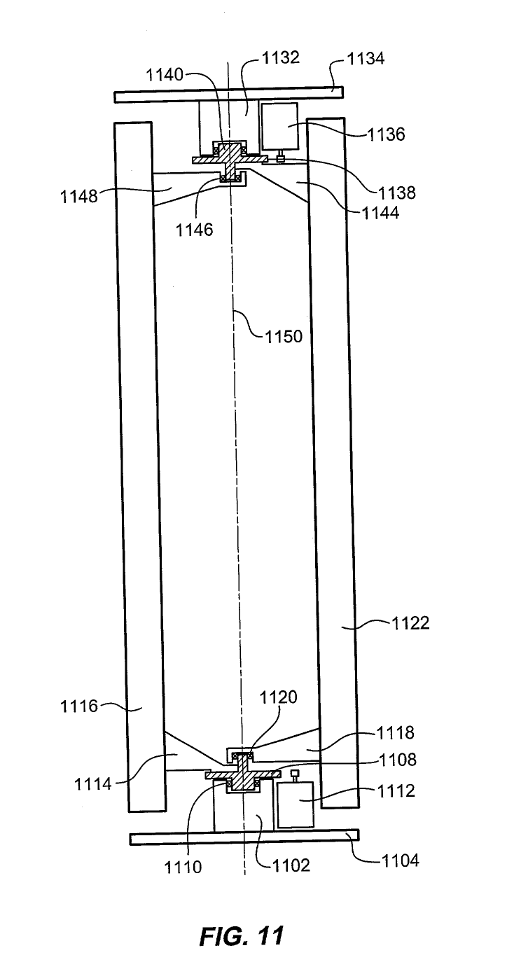

FIG. 11, illustrates dual concentric robots with end drives for theta rotation in accordance with a preferred embodiment of the present invention. A support 1102 is attached to the floor 1104 of the library storage module. A motor 1112 is also attached to support 1102. A rotating member 1108 fits into a slot 1110 in support 1102, which allows rotating member 1108 to rotate freely about axis 1150. A motor 1112 is attached to support 1102 and turns a belt (not shown) which, in turn, rotates rotating member 1108 about axis 1150. Rotating member 1108 is attached to an arm 1114, which is attached to Z-channel 1116. The rotation of rotating member 1108 rotates Z-channel 1116. A second arm 1118 has a slot 1120 which fits over rotating member 1108 and is also attached to Z-channel 1122. Second arm 1118 provides support to Z-channel 1122 and is able to rotate freely around and independently of rotating member 1108.

A second support 1132 is attached to ceiling 1134 of the library storage module. A second motor 1136 is also attached to second support 1132. A second rotating member 1138 fits into a second slot 1140 in second support 1132, which allows second rotating member 1138 to rotate freely about axis 1150. A second motor 1142 is attached to second support 1132 and turns a belt (not shown) which, in turn, rotates second rotating member 1138 about axis 1150. Second rotating member 1138 is attached to an third arm 1144 which is attached to Z-channel 1122. The rotation of rotating member 1138 rotates Z-channel 1122. A fourth arm 1148 has a slot 1146 which fits over rotating member 1138 and is also attached to Z-channel 1116. Fourth arm 1148 provides support to Z-channel 1116 and is able to rotate freely around and independently of rotating member 1138. Thus independent theta rotation of both Z-channels 1116 and 1122 is achieved.

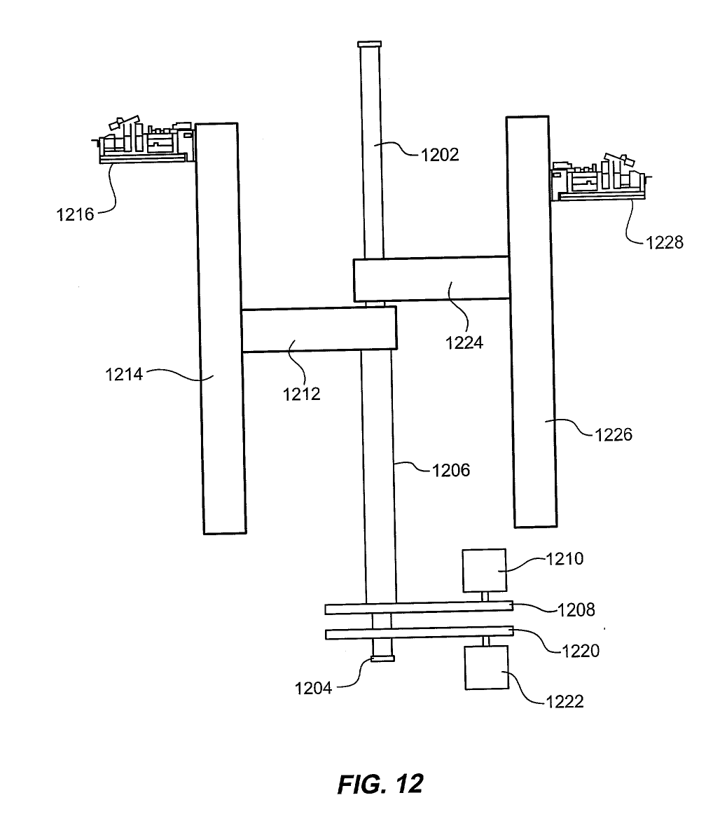

FIG. 12 illustrates dual concentric robots having inner 1202 and outer 1206 drive shafts in accordance with a preferred embodiment of the present invention. An inner drive shaft 1202 has a bearing 1204 at a lower extremity which fits into the floor (not shown) of the library storage module. Inner drive shaft 1202 is cylindrically disposed within an outer drive shaft 1206. The outer drive shaft 1206 is connected to a belt 1208 which is connected to motor 1210 which provides rotation to turn outer drive shaft 1206. Outer drive shaft 1206 is connected to a lower arm 1212 which is connected to Z-channel 1214. Z-channel 1214 is connected to robotic hand 1216.

Inner drive shaft 1202 is connected to a belt 1220 which is connected to motor 1222 that provides rotation to turn inner drive shaft 1202. Inner drive shaft 1202 is connected to an upper arm 1224 that is connected to Z-channel 1226. Z-channel 1226 is connected to a robotic hand 1228. Rotation of the inner drive shaft 1202 provides rotation of robotic hand 1228 within the library storage module. At an upper extremity of inner drive shaft 1202 is a second bearing 1230 which connects to the ceiling (not shown) of the library storage module, thus supporting inner drive shaft 1202.

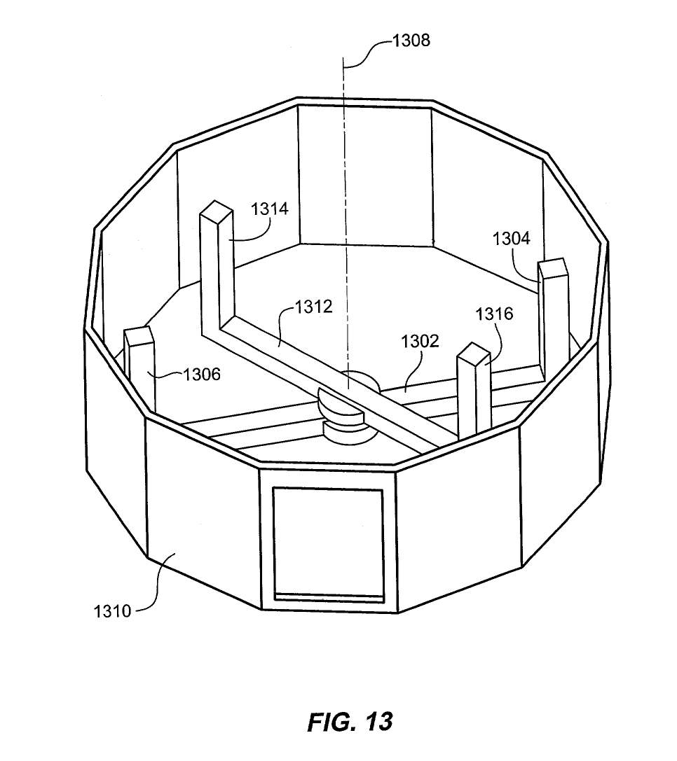

FIG. 13 illustrates concentric robots having redundant arms in accordance with a preferred embodiment of the present invention. A lower arm 1302 supporting two Z-channels 1304 and 1306 rotates about an axis 1308 within library storage module 1310. An upper arm 1312 is situated above lower arm 1302 to rotate about axis 1308 as well. Attached to upper arm 1312 are two Z-channels 1314 and 1316. Lower arm 1302 extends radially out from axis 1308 farther than does upper arm 1312. Thus, each arm, arm 1302 and arm 1312 may move independently of each other without the respective pair of Z-channels 1304, 1306, 1314, and 1316 of each arm, arm 1302 and arm 1312, colliding. Robotic hands (not shown) may be used on each pair of Z-channels 1304, 1306, 1314, and 1316. The robotic hands mounted on the outer Z-channels of Z-channel pairs 1304, 1306, 1314, and 1316 may extend outward as necessary from respective outer Z-channels of Z-channel pairs 1304, 1306, 1314, and 1316 such that each robotic hand may reach and grasp cassettes from the outer library storage module 1310. Robotic hands (not shown) mounted to the inner Z-channels of Z-channel pairs 1304, 1306, 1314, and 1316 service cartridges mounted on inner walls (not shown).

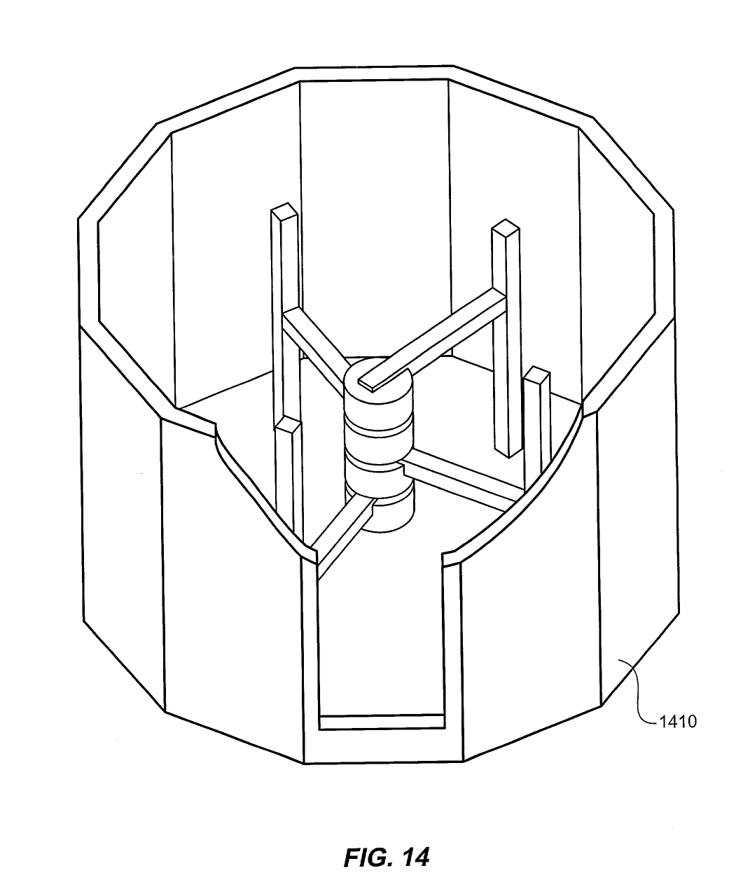

FIG. 14 illustrates an alternate embodiment in which four concentric independently rotatable arms are present within a library storage module 1410 in accordance with a preferred embodiment of the present invention.

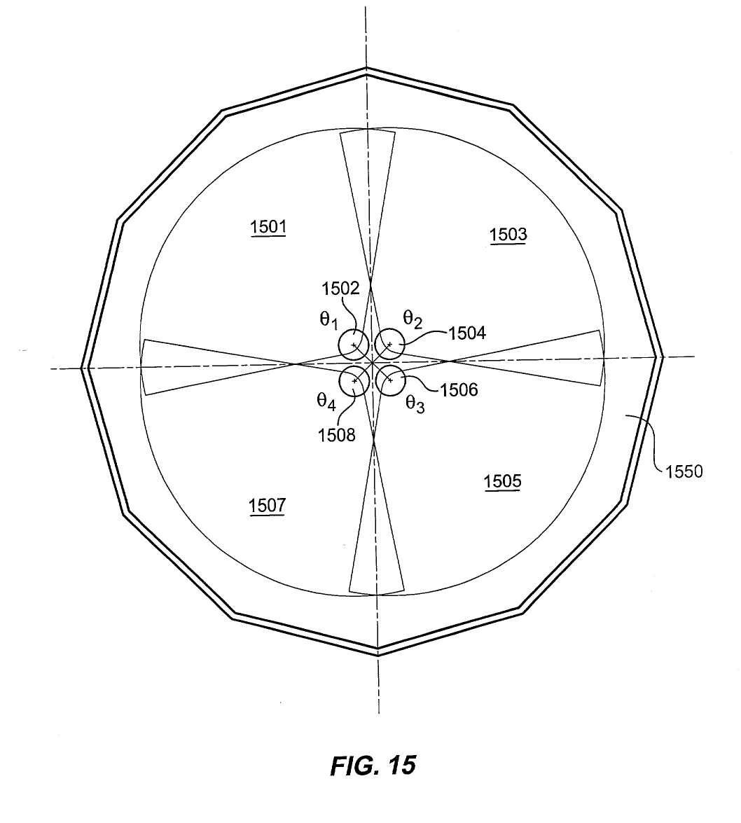

FIG. 15 shows a schematic diagram of four independently rotatable arms with off-centered axes of rotation in accordance with a preferred embodiment of the present invention. Each arm (not shown) are attached to a different rotation point, points 1502, 1504, 1506, and 1508. Each arm consists of a 4410 type cantilever beam arm holding a z-column. The arms are mounted to library floor 1550 off-center such that each arm assembly has its own theta rotation point as shown by rotation points 1502, 1504, 1506, and 1508. These separate rotation points 1502, 1504, 1506, and 1508 enables independent theta movements of multiple robots, although each robot would have its own zone of operation as shown by zones 1501, 1503, 1505, and 1507. Zones 1501, 1503, 1505, and 1507 are overlapping zones and provide for “pass through”. Total redundancy may not be achieved, but more jobs per hour per silo is accomplished. The somewhat elliptical sweep of the robotic hand is counteracted by a variable reach depth, adding size to the hand assembly, or a linkage designed to pivot the hand out further as the arm gets further from the LSM wall.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. An apparatus for retrieval of storage units from a library, the apparatus comprising:
a first center column having a first arm with first and second ends wherein the first end of said first arm is attached to said first center column and said first arm extends substantially radially outward from said first center column;
a first hand attached to the second end of said first arm for manipulating storage units from the library;
a second center column having a second arm with first and second ends wherein the first end of the second arm is attached to the second center column and said second arm extends substantially radially outward from said second center column; and
a second hand attached to the second end of said second arm for manipulating storage units from the library; wherein
said first arm and said second arm rotate about a same vertical axis of rotation; and
each arm and hand is independently moveable from the other arm and hand.

2. The apparatus of claim 1, wherein said first center column is attached at one end to a ceiling of the library and said second center column is attached at one end to a floor of the library.

3. The apparatus of claim 1, wherein each of said hands is moveable longitudinally along a respective one of said arms.

4. The apparatus of claim 1, wherein each of said center columns is substantially cylindrically symmetric.

5. The apparatus of claim 1, wherein said first center column is axially disposed within said second center column.

6. The apparatus of claim 1, wherein the library comprises walls arranged around a central axis and the storage units are stored in cells in the walls.

7. The apparatus of claim 1, wherein each of said center columns is substantially cylindrical.

8. A data tape storage and retrieval system, comprising:
a plurality of storage cells arranged radially around a central point, wherein the plurality of storage cells are configured to receive data storage objects;
a first rotational horizontal beam rotatable around the central point;
a second rotational horizontal beam rotatable around the central point;
a plurality of vertical supports, one of said vertical supports attached to one end of each of said rotational horizontal beams;
a plurality of gripping means configured for gripping data storage objects to be retrieved from said plurality of storage cells; and
means for movably attaching at least one of said gripping means to traverse each of said vertical supports; wherein
each of said rotational horizontal beams is capable of rotation independent of the rotation of the other of said rotational horizontal beams.

9. A data storage and retrieval system comprising:
a polygonal array of cells, wherein the polygonal array of cells are inwardly disposed with openings configured to receive data storage units;
a first robot unit, located within the polygonal array of cells, wherein the first robot unit transports a data storage unit to and from the polygonal array of cells; and
a second robot unit, located within the polygonal array of cells, wherein the second robot unit manipulates data storage units placed in the polygonal array of cells independently of the first robot unit.

10. The data storage and retrieval system of claim 9, wherein the data storage units are electronic magnetic storage cartridges.

11. The data storage and retrieval system of claim 9, wherein the polygonal array of cells is a circular array of cells.

12. The data storage and retrieval system of claim 9, further comprising:
collision avoidance means for preventing collisions between the fist robot unit and the second robot unit during operation.

13. The data storage and retrieval system of claim 9, wherein the first robot unit and the second robot unit both include a hand, wherein the hand is moveable to remove a data storage unit from a cell from the cylindrical array of cells.

14. The data storage and retrieval system of claim 9, wherein the polygonal array of cells in the data storage and retrieval system includes a major axis within the polygonal array of cells, wherein the first robot unit and the second robot unit are located along the major axis.

15. An apparatus for retrieval of storage units from a library, the apparatus comprising:
a first center column having a first arm with first and second ends wherein the first end of said first arm is attached to said first center column and said first arm extends substantially radially outward from said first center column;
a first hand attached to the second end of said first arm for manipulating storage units from the library;
a second center column having a second arm with first and second ends wherein the first end of the second arm is attached to the second center column and said second arm extends substantially radially outward from said second center column; and
a second hand attached to the second end of said second arm for manipulating storage units from the library; wherein
said first arm and said second arm rotate about a same vertical axis of rotation; and
each arm and hand is independently moveable from the other arm and hand.

16. The apparatus of claim 15, wherein each of said hands is moveable longitudinally along a respective one of said arms.

17. The apparatus of claim 15, wherein each of said center columns is substantially cylindrically symmetric.

18. The apparatus of claim 15, wherein said first center column is axially disposed within said second center column.

19. The apparatus of claim 15, wherein the library comprises walls arranged around a central axis and storage units are stored in cells in the walls.

20. The apparatus of claim 15, wherein each of said center columns is substantially cylindrical.

21. A data tape storage and retrieval system, comprising:
a plurality of storage cells arranged radially around a central point;
a first rotational horizontal beam rotatable around the central point;
a second rotational horizontal beam rotatable around the central point;
a plurality of vertical supports, one of said vertical supports attached to one end of each of said rotational horizontal beams;
a plurality of griping means for gripping data storage objects to be retrieved from said plurality of storage cells; and
means for movably attaching at least one of said gripping means to traverse each of said vertical supports, wherein each of said rotational horizontal beams is capable of rotation independent of the rotation of the other of said rotational horizontal beams.
